(19) United States
(12) Patent Application Publication
(10) Pub. No.: US 2026/0356697 A1
(43) Pub. Date: Nov. 12, 2026

(54) PORTABLE RENEWABLE ENERGY POWERED WATER PURIFICATION SYSTEM WITH REAL-TIME REMOTE DATA TRACKING

(71) Applicant: Hydrosun Technologies, London (GB)

(72) Inventor: Hamza Farrukh, London (GB)

(21) Appl. No.: 19/205,907

(22) Filed: May 12, 2025

(51) Int. Cl. C02F 1/00; H02S 20/30; H02S 30/20

(52) U.S. Cl. CPC C02F 1/002; C02F 1/006; C02F 1/008; H02S 20/30; H02S 30/20; C02F 2201/008; C02F 2201/009; C02F 2209/008; C02F 2209/40; C02F 2209/42; C02F 2301/08; C02F 2303/16

(57) ABSTRACT

A portable, self-contained water treatment system having a wheeled main casing integrating a submersible pump, prefilter, and filtration briefcase with interchangeable cartridges for water purification. Powered by a foldable solar power assembly, the system extracts raw water, filters it through multilayered media and configurable cartridges (serial or parallel), and stores purified water in a tank equipped with a level sensor. Water is dispensed via external taps connected to a distribution header. The solar assembly, stored in a compartment, deploys atop the casing, supported at adjustable angles. The system includes waste management via a backwash valve and offers smart monitoring of water quality and quantity. Constructed with durable materials, this mobile unit provides an efficient, solar-powered solution for producing and dispensing purified water in diverse settings.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to portable water treatment systems optimized for off-grid use. Embodiments of the invention are self-sustaining, relying on solar energy to provide sustainable, clean water in remote or underserved areas. Embodiments of the present invention are designed for rapid deployment and can be operational within minutes due to innovative mechanisms for quick and easy component insertion, removal, folding, unfolding, and storage.

### SUMMARY OF THE INVENTION

An object of the present invention is a fully self-contained water purifying system designed for rapid deployment comprising a main casing mounted on wheels, a pump connected to a prefilter via a delivery waterline, a solar power assembly electrically connected to the pump and a water hub, and water taps mounted externally on the main casing. The main casing comprises a top surface and a main casing lid. The pump is configured to draw raw water from a water source and deliver the raw water to the prefilter. The main casing houses a supporting board, the water hub, the prefilter configured to prefilter the raw water, an analog flowmeter, a filtration briefcase configured to purify prefiltered water, a water tank for purified water, a taps header configured to distribute the purified water to the water taps, a prefiltered waterline connecting the prefilter to the filtration briefcase, a purified waterline connecting the filtration briefcase to the water tank, and a distribution waterline connecting the water tank to the taps header. The prefiltered waterline is configured to deliver the prefiltered water from the prefilter to the filtration briefcase. The purified waterline is configured to deliver the purified water from the prefilter to the water tank. The analog flowmeter is configured to measure a water volume of the purified water and display the water volume on a readout externally mounted on the main casing. The water hub is configured to collect in real-time performance data and transmit the performance data globally to a remote portal. The performance data comprises water volume and water quality. The solar power assembly comprises two or more photovoltaic (PV) panels mounted on a hinged frame. The hinged frame is configured to enable a user to fold the solar power assembly into a folded state and unfold the solar panel assembly from the folded state to an extended state. In the folded state the two or more PV panels fully overlap with each other. In the extended state the two or more PV panels form a single plane. For ease or transportation the main casing is configured to removably store the pump connected to the delivery waterline, the delivery waterline, and the solar power assembly in the folded state. For rapid deployment of the water purification system, the main casing is configured to enable the user to open the main casing lid to access the solar power assembly and the supporting board, remove the solar power from the main casing, unfold the solar power assembly into the extended state, deploy the solar power assembly to convert solar energy to electricity by positioning the supporting board to support the solar power assembly in the extended state on the top surface of the main casing, and remove the pump from the main casing and position the pump in the raw water source. When deployed in sunlight, the solar power assembly is configured to power the pump, cause the pump to extract raw water from the water source, and cause the pump to pump the extracted raw water to be filtered sequentially through the prefilter and the filtration briefcase to produce the purified water and to be stored in the water tank.

In another object of the invention, the main casing further comprises a solar panel compartment, a briefcase compartment, and a pump compartment comprising a pump cover. The filtration briefcase comprises interchangeable filtration units configured to purify the prefiltered water and deliver the purified prefiltered water through the purified waterline. The pump compartment is configured to store the pump and the delivery waterline when the pump is not in use. The solar panel compartment is configured to fully accommodate the solar power assembly in the folded state while the solar panel is electrically connected to the pump and the water hub. The briefcase compartment is configured to removably house the filtration briefcase within the main casing. When the casing lid is open, the main casing and the solar panel compartment are configured to enable the user to slide the solar power assembly out from the solar panel compartment and enable the user to slide the solar power assembly in the folded state into the solar panel compartment. When the casing lid is closed, the main casing is configured to prevent access to the solar power assembly stored in the solar panel compartment and prevent access to the filtration briefcase housed in the briefcase compartment. When the solar power assembly is deployed, the main casing and the briefcase compartment are configured to enable the user to remove the filtration briefcase from the briefcase compartment, enable the user to insert the filtration briefcase into the briefcase compartment, and enable the user to access the interchangeable filtration units inside the filtration briefcase.

In yet another object of the invention, the main casing further comprises a panel edge support. The supporting board is configured to support the solar power assembly in the extended state at varying angles to incident sunlight when the solar assembly is deployed on top of the main casing. When the solar power assembly is deployed on top of the main casing, the panel edge support is further configured to prevent the solar power assembly from sliding forward and prevent the solar power assembly from sliding sideways.

In another object of the invention, the solar power assembly further comprises straps attached to the hinged frame configured to enable the user to utilize the straps to slide the solar power assembly in the folded state in or out of the solar panel compartment, and a stabilizer clip configured to cover a hinged connection of the hinged frame and prevent the solar power assembly from folding when in the extended state.

In yet another object of the invention, the filtration briefcase further comprises a briefcase inlet comprising an inlet easy-connector removably connected to the prefilter waterline, a briefcase outlet comprising an outlet easy-connector removably connected to the purified waterline, a cartridge inlet connector connected to the briefcase inlet, and a cartridge outlet connector connected to the briefcase outlet. The inlet easy-connector is configured to enable the user without using any tools to quickly and easily connect or disconnect the briefcase inlet and the prefiltered waterline. The outlet easy-connector is configured to enable the user without using any tools to quickly and easily disconnect or connect or disconnect the briefcase outlet and the purified waterline. When the solar power assembly is deployed, the main casing, the briefcase compartment, and the filtration briefcase are configured to enable the user to remove the filtration briefcase from the briefcase compartment by utilizing the inlet easy-connector and the outlet easy-connector to disconnect the filtration briefcase from the prefilter waterline and the purified waterline, and insert the filtration briefcase in the briefcase compartment by utilizing the inlet easy-connector and the outlet easy-connector to connect the filtration briefcase to the prefilter waterline and the purified waterline. The interchangeable filtration cartridges comprise a first filter cartridge and a second filter cartridge. The cartridge inlet connector, the cartridge outlet connector, the first filter cartridge, and the second filter cartridge are configured to enable the user to connect the first filter cartridge and the second filter cartridge in a serial filtration configuration for multistage filtration between the briefcase inlet and the briefcase outlet, and connect the first filter cartridge and the second filter cartridge in a parallel filtration configuration for increased filtration throughput between the briefcase inlet and briefcase outlet. The first filter cartridge is selected from the group consisting of reverse osmosis cartridge, ultrafiltration units, nano-filters, and activated carbon. The second filter cartridge is selected from the group consisting of reverse osmosis cartridge, ultrafiltration units, nano-filters, and activated carbon.

In another object of the invention, the system further comprises a prefilter waste line, a briefcase waste line, a waste line, and a backwash valve connected to the prefilter waste line, the briefcase waste line, and the waste line. The filtration briefcase further comprises a briefcase waste outlet equipped with a waste outlet easy-connector removably connected to the briefcase waste line. The interchangeable filtration cartridges are further configured to expel the filtration waste through the briefcase waste outlet. The prefilter further comprises a prefilter waste outlet connected to the prefilter waste line. The prefilter is configured to expel the filtration waste through the prefilter waste outlet. The backwash valve is configured to receive the filtration waste from the prefilter waste line, receive the filtration waste from the briefcase waste line, and enable a user to open the backwash valve to cause the filtration waste to be expelled through the waste line.

In yet another object of the invention, the pump is a submersible pump configured to be submersed into the water source. The submersible pump is enclosed in an external casing configured to protect the submersible pump by mechanically filtering the raw water from the water source. The storage water tank comprises a level sensor configured to send a control signal to the submersible pump indicative of a water level in the water tank. The submersible pump is configured to stop or start pumping raw water according to the control signal. The water tank has a water storage capacity of at least 250 liters. The solar power assembly has a surface area of at least 35 square feet in the extended state. The filtration briefcase has a depth of at least 7 inches, a length of at least 48 inches and a width of at least 20 inches. The prefilter has a volume of at least 1 cubic feet. The main casing has a volume of no more than 75 cubic feet and a height of no more than 4 feet. The water taps are mounted at a level below a bottom water level of the water tank.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is an illustration of a water treatment system according to an embodiment of the present invention.

FIG. 2 is a diagram illustrating an embodiment of the present invention.

FIG. 3 is a diagram illustrating an embodiment of a water treatment system according to the present invention.

FIG. 4 is a diagram illustrating embodiments of the present invention.

FIG. 4A is a diagram illustrating an edge support in an embodiment of the present invention.

FIG. 5 is a diagram illustrating embodiments of a filtration briefcase according to the present invention.

FIG. 6 is a diagram illustrating embodiments of water data tracking sensors according to the present invention.

FIG. 7 is a diagram illustrating an embodiment of a smart water hub.

FIG. 8 is a diagram of a power flow of for an embodiment of a smart water hub.

FIG. 9 is a diagram of an embodiment of the present invention.

For clarity all reference numerals may not be included in every figure.

### DETAILED DESCRIPTION OF THE INVENTION

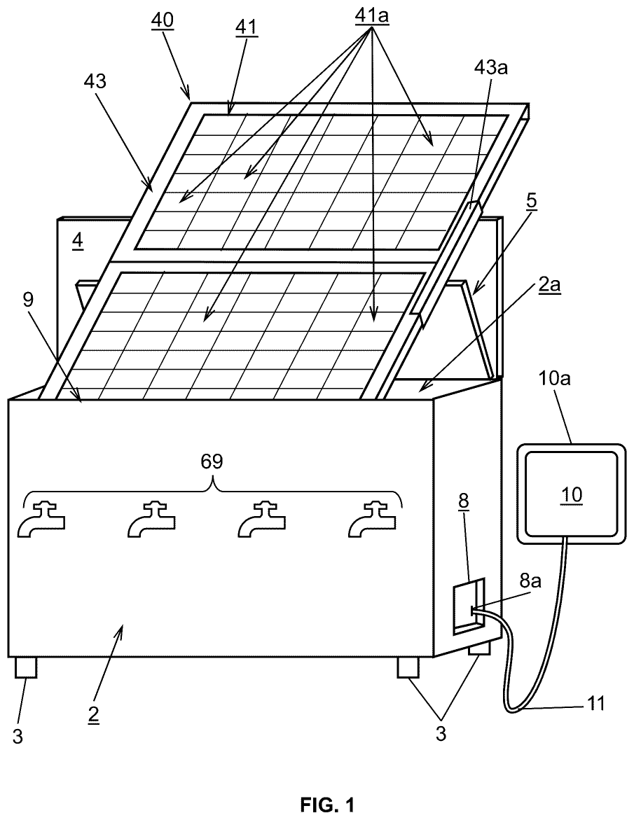

FIG. 1 illustrates a water treatment system 1 that is a compact, fully self-contained integrated unit combining all components necessary to deploy water purification and supply drinking water in remote locations without requiring additional supplies. All components of system 1 can be housed in one sturdy structure powered by solar energy making it highly versatile for various environments. Embodiments of water treatment systems 1 according to the present invention may integrate components into a solid, sturdy, and durable casing that can withstand challenging environments while remaining compact and portable enabling easy transport and rapid deployment in remote and difficult to access water-stressed areas. The performance of different embodiments may vary based on solar irradiance, geographic location, time of day, and environmental factors like shading or temperature. Water treatment systems may combine submersible water pumps with high-efficiency filters into a single, compact solution that can filter as much as 10,000 liters (and even more) of 99.9% bacteria-free water daily, providing safe drinking water for thousands of individuals. Various embodiments of the present invention may also incorporate robust data tracking using water hub 100.

Water treatment systems 1 according to the present invention comprise solar power assembly 40 that may be configured for secure storage inside main casing 2 of water treatment system 1, offering protection and portability. The solar power assembly may accommodate multiple (e.g., 2, 3, 4) solar panels ensuring adaptability to energy needs. Embodiments of water treatment system 1 may comprise a built-in large capacity stainless steel water storage tank 60 ensuring sufficient water reserve, durability and resistance to corrosion. Embodiments may comprise a filtration briefcase innovatively designed to accommodate interchangeable filtration types of (e.g., ultrafiltration, nanofiltration cartridges) within the same unit, providing flexibility based on water quality requirements.

In water treatment system 1 according to the present invention, raw water is pumped through a submersible pump 10 enclosed in an external casing 10a comprising a mechanical filter for preliminary mechanical filtration (e.g., a 10-micron mesh bag filter). The raw water is then transferred through a delivery waterline 11 into prefilter 20 and then to filtration briefcase 30. Purified water 14 from briefcase 30 may flow through one or more water meters 99, 100 downstream from briefcase 30. A first meter 100 may be a smart water hub 100 (or simply water hub 100) configured to measure the quality and quantity of the purified water 14, and to send data to a server. A second meter 99 may be an unconnected/local water meter 99 that may measure and/or calculate water volume, flow rate (e.g., cubic meters, liters/minute) and is available for local visual monitoring. A backwash valve 18 may collect filtration waste (e.g., wastewater, sludge) from prefilter 20 waste outlet 23 through prefilter waste line 23a and/or from briefcase waste outlet 33 through briefcase waste line 33a and deliver the filtration waste to waste line 19. Backwash valve 18 may normally be closed and a user may open backwash valve 18 to drain the filter waste through waste line 19.

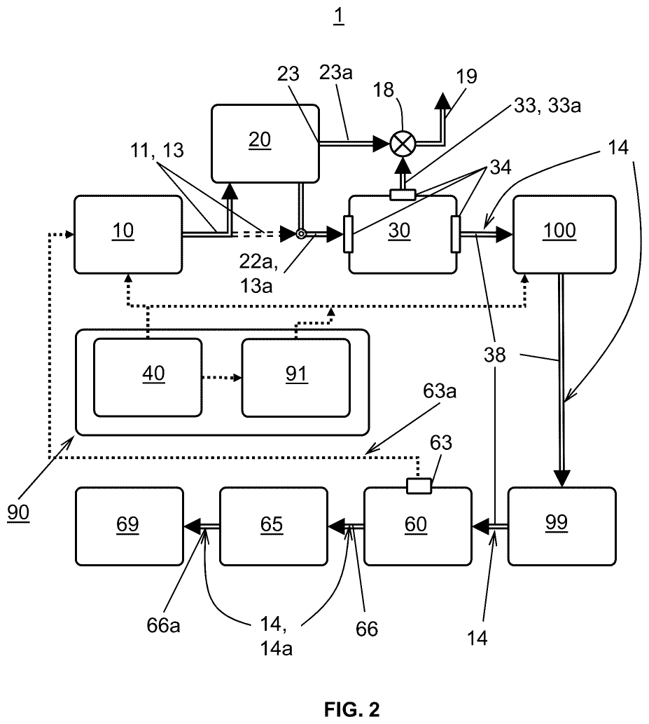

FIG. 2 illustrates water flow (shown as double lines, with arrows indicating direction of the water flow) in an embodiment of water treatment system 1 from pump 10 submerged in a water source (not shown) to end user (e.g., taps 69) and water measurement using smart water hub 100 and local water meter 99. Water treatment system 1 enables underground or other untreated raw water 13 to be filtered for consumption by end users through taps 69 while tracking water treatment performance (e.g., volume, flow, throughput) and water quality (e.g., Total Dissolved Solids). System 1 may use a hybrid monitoring approach using both smart water hub 100 and unconnected/local water meters (e.g., analog flow meter) for reliability and redundancy. Water treatment system 1 may be designed for efficient water extraction, purification, distribution, storage, measurement, and remote tracking, ensuring clean and accessible water supply in remote and difficult to access locations, while providing robust monitoring capabilities.

The water purification process begins with submersible pump 10 drawing raw water 13 from a water source, such as natural or artificial water storage locations (e.g., well, reservoir, standing runoff). Pump 10 may be contained in a protective casing and may comprise a mechanical mesh filter to filter out larger objects (e.g., rocks, debris).

Through delivery waterline 11, pump 10 may deliver raw water 13 from the water source to a prefilter 20, which may prepare raw water 13 for further purification and treatment by removing larger particles, sediments, VOCs, chemicals and other impurities from raw water 13 to produce prefiltered water 13a. Prefilter 20 may incorporate micro filtration, an activated carbon filter, or may be a multi-layer prefilter 20 comprising layers of filter media (e.g., sand, gravel, activated carbon, fibers, etc.). Prefilter 20 may comprise prefilter inlet 21 for receiving raw water 13, prefilter outlet 22 for prefiltered water 13a, and a prefilter waste outlet 23 for sludge and/or wastewater.

Delivery waterline 11 may enter main casing 2 near the top to ensure raw water continues its flow under gravity in the event of temporary failure of pump 10. Such an embodiment in which delivery waterline 11 is raised so that raw water enters casing 2 above the level of the water source surface and of the water taps 69 may create a siphoning effect enabling filtration and/or water delivery to continue in the event of a pump 10 failure.

Next, the water moves into filtration briefcase 30, a compact, portable, specialized filtration unit. Filtration Briefcase 30 receives prefiltered water 13a or alternatively raw water 13 (alternative indicated with a dashed double line) and purifies it, removing finer contaminants, chemicals, or microorganisms to ensure it meets safety and quality standards. Purified water 14 exits filtration briefcase 30 through outlet 32 to purified waterline 38. Purified waterline 38 may run through a smart water hub 100 and/or local flow meter 99.

Purified waterline 38 is connected to a high capacity (e.g., 200-400 liters) water storage tank 60 which may be built from food grade material (e.g., stainless steel-304) configured (e.g., wall thickness of 1.5-3 mm) for outdoor storage of purified water 14 for later use to enable continued water availability during high demand or when power source 90, or any filtration components are unavailable (e.g., maintenance, technical problems). Water tank 60 can also help regulate pressure and stabilize water treatment system 1 using a level sensor 63 to provide a level control signal 63a to start or stop submersible pump 10 depending on water level in tank 60 ensuring continuous water supply and maintaining the water level in tank 60. Water storage tank 60 may comprise an additional outlet 64 to connect to additional storage capacities or to an external distribution system (not shown). Additional outlet 64, tank outlet 62, and tank inlet 61 may also comprise easy-connect connectors 64a, 62a, and 61a respectively enabling easy connecting and disconnecting of water tank 60 for maintenance, installation, replacement, and expanding capacity, among other benefits.

Water tank 60 can be designed to store at least 250 liters of purified water 14 without substantially increasing the overall size of main casing 2. For example, in a preferred embodiment water tank 60 may store about 280 liters of purified water 14 while having outside dimensions of about 400 mm (15.75 inches) by 1200 mm (47.25 inches) by 600 mm (23.6 inches) and wall thickness of 2.5 mm (0.1 inch). Main casing 2 may be configured to accommodate such large capacity water tank 60 so that only the smallest dimension of tank 60, its 400 mm width in the above embodiment, will contribute to the overall size of main casing 2, while the remaining dimensions of water tank 60 are smaller than the corresponding dimensions of solar panel assembly 40 and do not affect the overall size of main casing 2.

Smart water hub 100 may track water usage and may enable real-time data monitoring and remote management capabilities. Smart water hub 100 operates on renewable solar energy provided by solar power assembly 40, and a backup power source which may be power rechargeable power supply 91 or battery 104 for uninterrupted functionality during periods without sunlight. The dual power source design ensures seamless data collection and reliable communications. Smart water hub 100 ensures effective monitoring and operational oversight enabling central performance tracking of water treatment system 1 by measuring and transmitting system performance data 120.

Local water meter 99 may measure the volume of purified water 14 flowing downstream of briefcase 30, before or after water storage tank 60. Local water meter 99 may comprise display 99a observable on the outside of main casing 2, and may enable a non-digital record of system 1 performance or water usage (by, e.g., manually recording the reading, printout via a local printer, etc.). Water meter 99 may be a purely analog/mechanical meter that does not rely on external power and may provide one or more of a total water volume (e.g., cubic meters, liters) and throughput over a period of time (e.g., cubic meters/day, liters/hour). Throughput values may also be calculated from total water volume by periodically recording the water volume at known intervals (e.g., every day, every month, etc.) or by periodically resetting (e.g., zeroing out) the water volume readout. Local water meter 99 may complement smart water hub 100 by providing a secondary monitoring system as a backup, e.g., during connectivity, and a second readout to ensure accurate tracking of water consumption.

Distribution waterline 66 from water tank 60 leads to a water taps header 65 (e.g., a manifold or header) that channels and distributes water to multiple water tap outlets 69 (e.g., points of use, such as faucets or spigots). Water taps 69 may be mounted on the outside of main casing 2. From the taps header 65 stored purified water 14a flows to water taps 69 that may be connected to taps header 65 directly or through tap waterline 66a where purified water 14 may be accessed for consumption or other purposes. Water taps 69 represent the direct delivery of purified 14 (or stored water 14a) to end-users. Water taps 69 may be positioned below the bottom water level (e.g., the bottom of the tank, minimum water level) of tank 60 to enable gravity flow of stored water to water taps 69.

FIG. 2 illustrates the main casing 2 of water treatment system 1 which may be built from durable materials, preferably corrugated (for added sturdiness) metal sheets. Main casing 2 is configured to integrate the components of water treatment system 1 into a single portable unit. Main casing 2 is mounted on wheels 3 for portability and ease of adjustment and transportation.

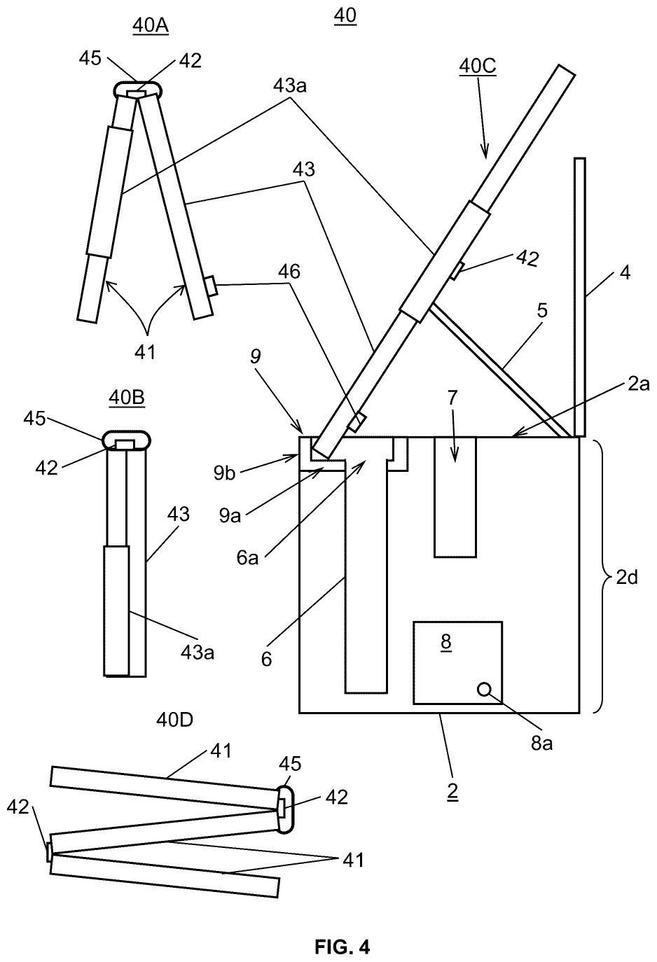

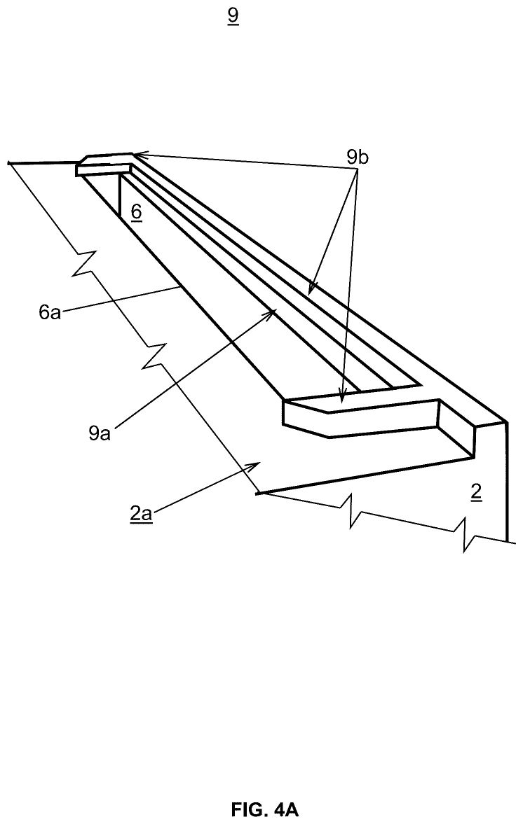

Main casing 2 may comprise a solar panel compartment 6 designed to fully store (e.g. allow main casing lid 4 to be closed) solar power assembly 40 when in a folded state 40B. Solar panel compartment 6 may be oriented within main casing 2 for efficient storage of solar power assembly 40 and designed to minimize the overall size of main casing 2. In a preferred embodiment panel compartment 6 may be vertical (e.g. perpendicular to top surface 2a) as illustrated on FIG. 4 with a custom-fit opening 6a designed to closely accommodate solar power assembly in folded state 40B allowing it to freely slide in and out of panel compartment 6. Solar panel compartment 6 may be designed to be opened and accessible from the top of main casing 2 to allow access for easy storage and retrieval of solar power assembly 40 without disconnecting electrical connector 46. Opening 6a of solar panel compartment 6 may be recessed below the top surface of main casing 2 to form panel edge support 9 allowing secure positioning of solar power assembly 40 as illustrated in FIG. 4. In another embodiment illustrated in FIG. 4A, main casing 2 may be configured so that opening 6a of panel compartment 6 is on top surface 2a (e.g., flush with the top surface) and includes edge support 9 raising above top surface 2a. FIG. 4A illustrates edge support 9 comprising vertical support 9b, and horizontal support 9a formed between the opening 6a of panel compartment 6 and vertical support 9b. When solar power assembly 40 is deployed, the bottom edge of hinged frame 43 may rest on horizontal support 9a as shown in FIG. 4. Vertical support 9b prevent deployed solar power assembly 40 from sliding forward and may also wrap around opening 6a to also prevent deployed solar power assembly 40 from sliding sideways. In a preferred embodiment, the width of horizontal support 9a is 3 to 6 centimeters (cm) and the height of vertical support 9b is between 2 cm to 5 cm above the above the top surface (or above the recessed opening of panel compartment 6) enabling edge support 9 to securely support deployed solar assembly 40 with hinged frame thickness of 2 cm to 6 cm. Edge support 9b may be wider than panel compartment opening 6a and preferably about 1 cm to 3 cm wider than solar power assembly 40 to enable the bottom of deployed solar power assembly 40 (e.g., in extended state 40C) to closely fit within vertical support 9b an restricting sideways movement (having, e.g., 0.5 to 1.5 cm gaps on each side). It should be understood that different configurations and dimensions of support edge 9 and panel compartment 6 will fall within the scope of the present invention depending on the size and weight of solar assembly 40, number of photovoltaic (PV) panels 41, desired angles of deployment, necessity to slide assembly 40 sideways to provide clearance for cables, waterlines, or other components, and other factors.

Main casing 2 may also comprise a briefcase compartment 7 open to the top of main casing 2 and custom fit to closely accommodate and enable easy access to filtration briefcase 30. As illustrated in FIG. 4, briefcase compartment 7 may be configured to be accessible while solar power assembly is deployed to allow quick maintenance, replacement, or reconfiguration of interchangeable cartridges 35. Main casing 2 may also comprise externally accessible pump compartment 8 that a user may access via a pump cover or lid on the outside surface of main casing 2. Pump compartment 8 is designed to fully and securely store pump 10 when not in use (e.g., transportation, storage) and provides an aperture 8a for delivery waterline 11 to enter casing 2 enabling storage of pump 10 without disconnecting it from water treatment system 1.

Main casing 2 also may comprise casing lid 4 and supporting board 5. Supporting board 5 enables securely changing the angle of solar power assembly 40. FIG. 4 illustrates a slidable supporting board 5 that can be adjusted to the required angle to maximize sun exposure of solar power assembly 40. Casing lid 4 may also be used to support solar power assembly 40 in addition to supporting board 5 for added support, or instead of supporting board 5 to achieve different angles of sun exposure. To eliminate weight and bulk, embodiments of main casing 2 may only comprise lid 4 designed to be utilized as supporting board 5 when system 1 is deployed and serve as a lid when main casing 2 is closed (e.g., during transportation).

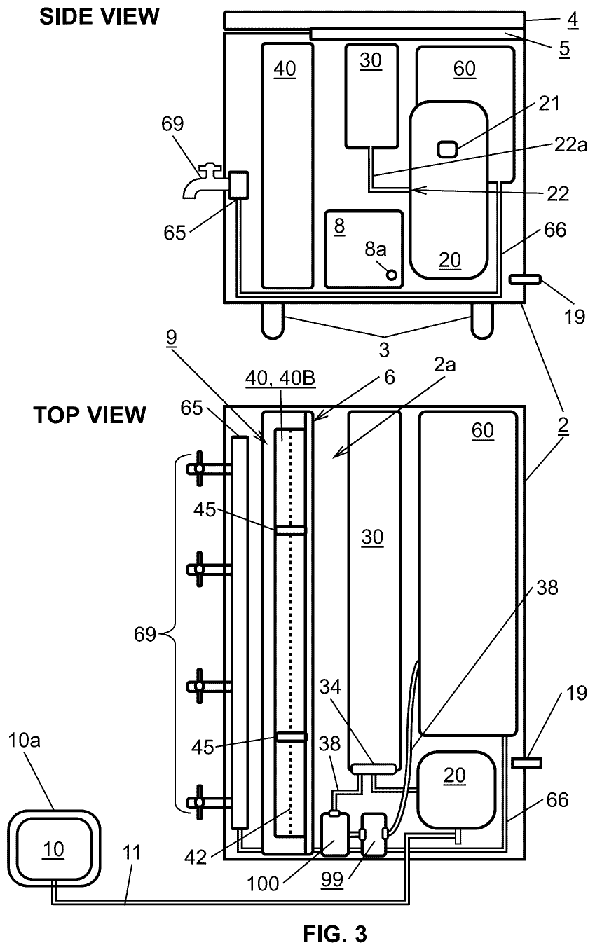

As illustrated on FIG. 3, main casing 2 may also be configured to house a large capacity water tank 60, prefilter 20, water tap manifold 65 and connecting water pipes. Water taps 69 may be mounted on the outside of main casing 2.

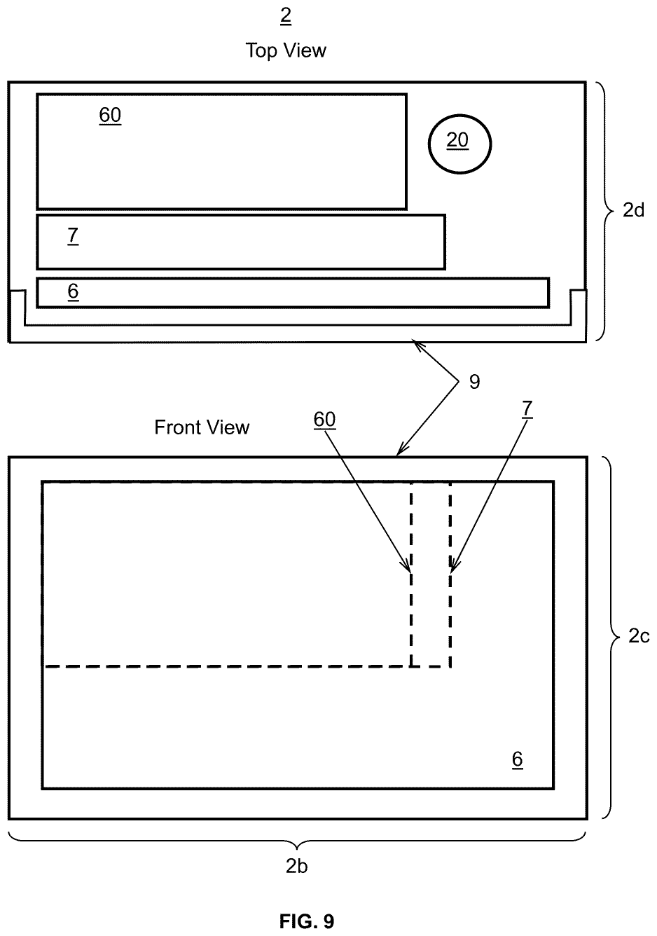

FIG. 9 illustrates a top view and front view of an embodiment of main casing 2 configured for compactness. Panel storage compartment 6, briefcase compartment 7 (indicated with dashed line in in the front view) and water tank 60 (indicated with dashed line in in the front view) are arranged parallel to each other. In such configuration, the depth of main casing 2 can be minimized so that it is sufficient to accommodate the thickness of folded solar panel 40, the depth of filtration briefcase 30, and the smallest dimension (e.g., width) of water tank 60. In this embodiment the size of the front of main casing 2 (e.g., height and width) may be determined based on the size of folded solar panel assembly 40, which closely fits within solar panel compartment 6. A preferred embodiment may comprise main casing 2 having a width 2b of about 75 inches, height 2c of about 47 inches (to, e.g., enable easy access inside main casing without a step stool), and depth 2d of about 36 inches (e.g., volume of about 73.5 cubic feet), configured to fully house a two-PV-panel solar power assembly 40 measuring about 65 by 39 by 3.15 inches when folded, a water tank 60 with capacity of at least 250 liters, a filtration briefcase 30 with a depth of least 7 inches, length of at least 50 inches, and width of at least 24 inches, a prefilter with a capacity of about 1 cubic foot (e.g., approx. 28 liters) or at least 20 liters, submersible water pump 10, taps header 65, delivery waterline 11, prefiltered waterline 22a, purified waterline 38, distribution waterline 66, tap waterline 66a, and water hub 100.

Renewable power source 90 comprises solar power assembly 40 and rechargeable power supply 91. Rechargeable power supply 91 may comprise a power source sufficient to power both pump 10 and water hub 100. Alternatively, rechargeable power supply 91 may comprise a high-power rechargeable supply 91a for powering pump 10 and any other high power devices of system 1, a backup battery 104 for powering water hub 100, and a combination of high-power rechargeable supply 91a and backup battery 104. Rechargeable power supply 91, high-power rechargeable supply 91a, and backup battery 104 may be recharged by solar power assembly 40 when sufficient solar energy is available, and may provide backup power 49 when there is no sufficient solar energy.

The solar power assembly operates by converting sunlight into electricity using photovoltaic (PV) cells to generate electric charge, which is conditioned and supplied through solar power connector 46 as solar generated electric power 47 (or solar power 47, for simplicity) to power the various aspects of system 1. Solar power 47 voltage preferably is approximately 32 Volts Direct Current (VDC), but various other implementations are possible. Solar power 47 may be used to power the components of water treatment system 1, including one or more of the pump, data collection circuits, transmitters, control units, and other components that may require electric power. Solar power assembly 40 may supply solar power 47 to simultaneously power pump 10 and smart water hub 100, and to charge rechargeable power supply 91 and backup battery 104.

Solar power assembly 40 illustrated in FIG. 4 comprises two or more photovoltaic (PV) panels 41 mounted on a hinged frame 43 and connected together with hinges 42 (e.g., C-cut hinges, hinges that enable 180 degrees swing). Hinged frame 43 is designed to fold (e.g., to be fully closed at 0 degrees between the panels) or tilt at various degrees, allowing for compact storage when not in use and optimal sunlight exposure when deployed at a 180° angle. Frame 43 and hinges 42 enable solar power assembly 40 to be fully folded (e.g., at 0 degrees) so that the PV panels 41 fully overlap with each other for storage, or to be fully extended (e.g., at 180 degrees with the PV panels forming a single plane/surface) for deployment to generate power. PV panels 41 are electrically connected to work as a unit and to generate electricity when exposed to sunlight using multiple PV cells 41a. FIG. 4 illustrates partially open two-panel solar assembly 40A and partially open three-panel solar assembly 40D, solar power assembly 40 in folded state 40B, and solar power assembly 40 in extended state 40C deployed on top of main casing 2, supported by supporting board 5 and supporting edge 9. In folded state 40B solar assembly 40B is configured to slide in and out of panel compartment 6 as illustrated in FIG. 3. Frame 43 is hinged at the base of each panel and may comprise straps 45 to help a user in removing or inserting solar power assembly 40 into compartment 6. Extended state 40C may be stabilized by stabilizer clip 43a (e.g., a U-clamp, or U-shaped channel) designed to be positioned over the hinged connection between PV panels 41 to prevent frame 43 from folding/bending at hinge 42. Clip 43a (or stabilizer clip 43a) may be manually positioned over the hinged connection between PV panels 41, or may be designed so that it slides into position to secure the hinged connection in extended state 40C, and when solar power assembly is in folded state 40B for storage, clip 43a may slide out of the way as illustrated in FIG. 4.

Each PV panel 41 preferably has a sun-exposed surface area of about 17.74 square feet (approx. 1.65 sq. meters) and is capable of generating about 250 to 330 Watts of electric power depending on sunlight and other factors. Accordingly, a two panel solar power assembly can generate 500-660 Watts of solar power 47. Each PV panel preferably is approximately 40 mm (approx. 1.5 in.) thick and has a sun-exposed surface of about 65 inches by 39 inches (e.g., 1.65×1 meters). In a preferred embodiment PV panels 41 are hinged along the 65-inch length, resulting in a folded assembly with dimensions of about 65 inches by 39 inches by 3.15 inches (1650 mm×1000 mm×80 mm) for two PV panels 41, and can slide into panel compartment 6 of main casing 2 along its 39-inch height. In these embodiments storage of solar panel assembly when folded only requires panel compartment opening 6a that is approximately 95 mm wide and 1665 mm long (about 3.75 inches by 65.5 inches) to accommodate protruding components, such as hinges 42, stabilizer clip 43a, and connector 46. If a PV panel 41 is added to increase solar power 47 generation a three-panel solar power assembly 40 will only increase the thickness of folded solar panel assembly 40 and panel compartment opening 6a by about 40 mm (approx. 1.5 in) without affecting the length and height of panel compartment 6 and main casing 2.

Filtration Briefcase 30 may be a portable water purification unit configured to use interchangeable filtration cartridges 35 and configured for easy insertion into and removal from briefcase compartment 7 and for easy access to interchangeable filtration cartridges 35. Filtration briefcase 30 enables enhanced portability, usability, serviceability and installation time. Filtration briefcase 30 is easily installed and changed within water treatment system 1 using easy-connect fittings 34, for example, union pipe connectors (e.g., PVC unions) enable secure temporary connection of waterlines or pipes without special tools, without sealant, bonded coupling, or other similar connection methods. Easy-connect fittings 34 (interchangeably referred to as easy-connectors 34, union fitting, and pipe unions) allow waterlines, for example prefiltered waterline 22a and briefcase inlet 31, to quickly and easily be connected, disconnected, or reconnected with minimal or no deformation of the pipes. FIG. 4 illustrates connected and disconnected examples of a simple pipe union easy-connector 34 having an outside thread end and an end with a nut (inside thread) that enable a user to quickly connect and disconnect the waterline by hand-tightening or loosening the nut. Interchangeable filtration cartridges 35 enable the filtration briefcase to provide flexibility and adaptability to different water purification needs. An embodiment of briefcase 30 may comprise two hollow fiber ultrafilters 35 arranged in series so that water first passes through first ultrafilter 35a (e.g., hollow fiber model ULP-4040) and its output feeds into second ultrafilter 35b producing double-filtered purified water.

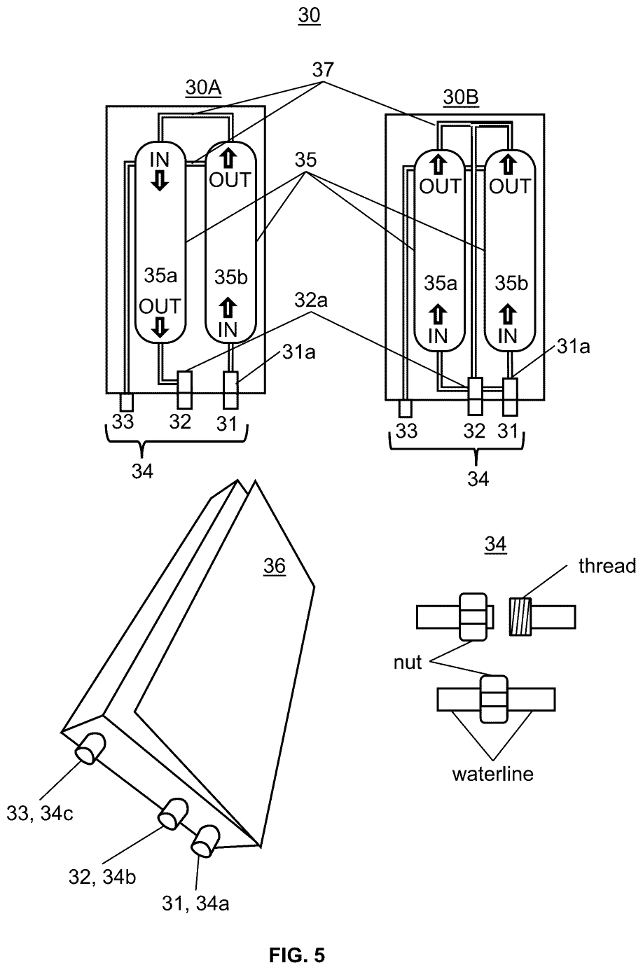

FIG. 5 illustrates embodiments of filtration briefcase 30, a portable water filtration component of system 1. Briefcase 30 is a durable, non-corrosive (e.g., metallic) container with a hinged lid 36 comprising interchangeable filter cartridges 35 (e.g., cylindrical, tubes) connected by pipes and fittings to each other and to the inlet and outlet of the briefcase. Briefcase 30 comprises briefcase inlet 31 and briefcase purified water outlet 32, and briefcase waste outlet 33. Briefcase inlet 31 and briefcase outlets 32, 33 have easy-connect fittings 34 mounted on the exterior of briefcase 20 for quick and easy attachment to, and detachment from, waterlines/pipes (e.g., prefiltered waterline 22a, delivery waterline 11) without opening briefcase 30, enabling easy installation and removal of filtration briefcase 30 for maintenance and filter cartridge 35 replacement. Briefcase inlet 31 and briefcase outlets 32, 33 may also be configured with easy-connect fittings on the inside of briefcase 30 to enable quick and easy connecting and disconnecting of interchangeable filtration units 35. Furthermore, filtration units 35 may include easy-connect fittings 34 for easy connection or disconnection of filter waterlines 37, to allow quick and easy replacement or re-configuration of filtration units 35 (e.g., from serial to parallel filter configuration). Water inlet 31 may further comprise a cartridge inlet connector 31a configured to enable interchangeable cartridges 35 to be connected to water inlet 31 in different configurations. Water outlet 32 may also comprise a cartridge outlet connector 32a configured to enable interchangeable cartridges 35 to be connected to water outlet 32 in different configurations.

Filtration briefcase 30 comprises interchangeable filtration units 35 (e.g., cartridges, tubes, etc.) that are removably mounted inside the briefcase 30 and accessible through a hinged lid 36. Each of first and second interchangeable filtration unit 35a, 35b, may be reverse osmosis (RO) membranes, ultrafiltration (UF) units (e.g., made of hollow fibers), nano-filters for enhanced filtration, activated carbon filters, or others commonly used for water purification. Briefcase 30 enables a user to connect filtration units 35 in a serial filtration configuration 30A for multi-stage filtration (e.g., ultra-filtration feeding into nano-filtration) or in a parallel configuration 30B for increased throughput. Switching between serial configuration 30A and parallel configuration 30B may be achieved by changing how filter cartridges 35 connect to cartridge inlet connector 31a and cartridge outlet connector 32a. For example, parallel configuration 30B illustrated in FIG. 5 may be achieved by connecting the inputs of both filter cartridges 35 to inlet connector 31a and the outputs of both filter cartridges 35 to outlet connector 32a. Alternatively, serial configuration 30A illustrated in FIG. 5 may be achieved by connecting the input of filter cartridge 35b to inlet connector 31a, the output of filter cartridge 35b to the input of filter cartridge 35a and the output of filter cartridge 35a to outlet connector 32a.

Filtration briefcase 30 may also comprise water inlet 31 (for receiving raw water 13 from delivery waterline 11 or prefiltered water 13a from filtered waterline 22a), briefcase water outlet 32 for purified water 14, and briefcase waste outlet 33. Water inlet 31, briefcase water outlet 32, and briefcase waste outlet 33 may each comprise an easy-connect fitting 34 enabling easy attachment and detachment of waterlines. Water inlet 31 may be connected via easy-connector 34a to prefiltered waterline 22a, or to delivery waterline 11. Briefcase water outlet 32 may be connected to storage waterline 38 via easy-connector 34b to deliver purified water 14 to water tank 60, or alternatively to an external water distribution system (not shown). Briefcase waste outlet 33 may be connected via easy-connector 34c to backwash valve 18 through briefcase waste line 33a to expel filtration waste (e.g., wastewater, brine, sludge).

Detachable connection points 34 for the water inlet 31, purified filtered water outlet 32, and waste outlet 33 enable briefcase 30 to easily be connected or disconnected from water treatment system 1 for deployment, servicing, transport, or integration. The hinged lid 36 allows for quick access to filtration units 35 for maintenance, replacement, or reconfiguration.

Interchangeable filter units 35 enable a high capacity, multi-stage purification process for removing bacteria, viruses, sediments, and chemical contaminants. Depending on the type of filtration (e.g., RO, UF) and power requirements of pump 10, system 1 could produce several hundred liters per hour of purified water 14 powered by the solar panels (using, e.g., 250-660 watts).

Filtration briefcase 30 may be constructed from durable, corrosion-resistant material suitable for outdoor and portable use, preferably Aluminum Composite Panel (ACP) sheets. Filtration briefcase 30 is designed with a compact size configured to slide into briefcase compartment 7 while accommodating at least two interchangeable filtration units 35a, 35b positioned side-by-side, together with connecting waterlines and easy-connectors as illustrated in FIG. 5. Filtration units 35 preferably are standard 4-inch by 40-inch filtration units (e.g., models designated with 4040) allowing filtration briefcase 30 to provide high filtration throughput in a compact size that is 5 to 8 inches deep, 46 to 55 inches long, and 10 to 24 inches wide. A preferred embodiment of filtration briefcase 30 is about 7 inches deep, 53 inches long and 24 inches wide providing a compact size while allowing easy access and room for routing and replacing interchangeable filter cartridges 35 that may be longer than 40 inches. Briefcase compartment 7 may be a slot custom designed to closely fit filtration briefcase 30, for example having a width of about 7.25 to 8 inches (e.g., corresponding to the depth of filtration briefcase) and length of about 48.25 to 49 inches for the preferred embodiment of filtration briefcase 30 described above. Briefcase compartment 7 may be parallel to panel compartment 6, so that only the depth of filtration briefcase 30 (i.e., the width of the opening of briefcase compartment 7) contributes to the overall size of main casing 2, because the length and width of filtration briefcase 30 are smaller than the dimensions of solar panel assembly 40.

Embodiments of the present invention are designed for rapid deployment at a water source location, enabling two people to fully unpack and deploy system 1 in less than 15 minutes, and preferably in approximately 10 minutes. System 1 is transported with all components fully stored inside main casing 2, and with prefilter 20 and filtration briefcase 30 connected and ready to purify water when pump 10 begins supplying raw water. Rapid deployment near a water source location only requires removing pump 10 from pump compartment 8 and placing it in the water source, deploying solar power assembly 40 on top of main casing 2, and optional visual system check. Deploying solar panel assembly 40 involves pulling it out from solar panel compartment 6, unfolding it, securing it with stabilizer clip 43a, and positioning it on top of main casing 2 so that it is supported by supporting edge 9 and supporting board 5 at the desired exposure angle.

Smart water hub 100 is configured to track in real-time performance data 120 of system 1 including, for example, water quality data 125 and water volume data 126 for purified water 14. Water quality data 125 may comprise various measurements, for example, Total Dissolved Solids (“TDS”) in parts-per-million (“ppm”). Water volume data 126 may represent the amount of water filtered in different time periods (e.g., day, month, life of the system, since last restart, etc.). Smart water hub 100 collects water volume data 126 from flowmeters 112 and water quality data 125 from water quality sensors 113, and transmits the data to a central portal 130. Smart water hub 100 may be associated with a unique identifier 121, which also represents the water treatment system 1 in which the smart water hub 100 is installed. When multiple water treatment systems 1 are deployed, smart water hub 100 enables centralized tracking, data collection, and monitoring of all deployed systems 1, by transmitting the unique identifier 121 together with system performance data 120 from each water treatment system 1, where the unique identifier 121 is associated with the water treatment system 1 and its smart water hub 100. By gathering and transmitting performance data 120, smart water hub 100 enables enhanced operational efficiency and efficient and responsive (e.g., faster maintenance, technical response, if data indicates problems) delivery of services.

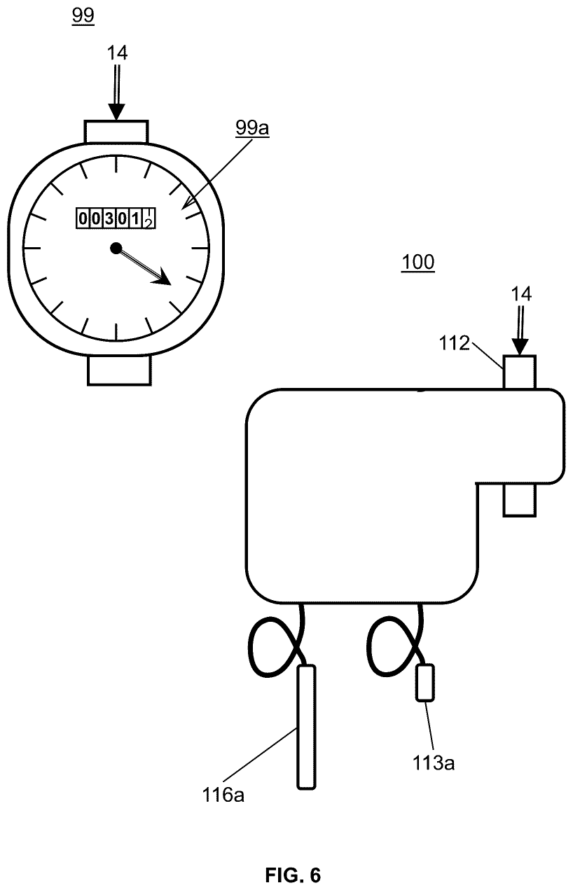

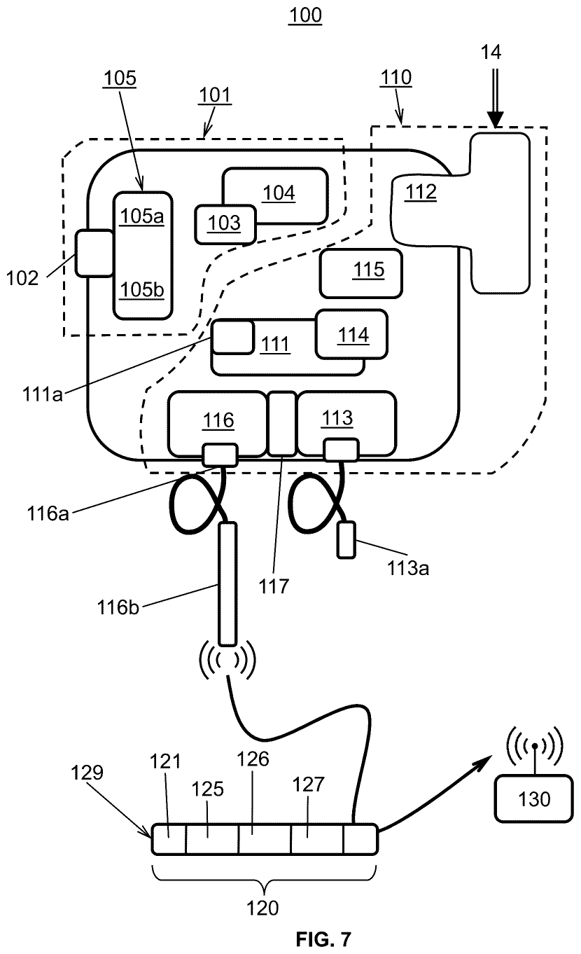

FIGS. 6, 7 illustrate water hub 100 comprising antenna port 116a (e.g., IPEX antenna input for a GSM antenna), a power connector 102 (e.g., DC wiring connector, red/black cable pair), and a flowmeter 112. FIG. 7 illustrates smart water hub 100 comprising a power circuit 101 (shown with a dashed line) and a controller circuit 110 (shown with a dashed line).

Power Circuit 101 (indicated with dashed line) is configured to be powered by solar assembly 40 and to use rechargeable (e.g., lithium-ion) or non-rechargeable battery 104 backup (or similar rechargeable power supply 91). Power circuit 101 may comprise power connector 102, charging module 103, backup battery 104 (e.g., 3.7 VDC to 4.2 VDC 37 Wh 10,000 mAh Li-Ion), boost-and-buck converter 105, and a battery supply disconnect (not shown, e.g., P-Channel MOSFET). Power circuit 101 may draw power from either solar power assembly 40 or battery 104 and supply steady control power 108 to the components of smart water hub 100. Embodiments of control circuit 110 may operate at control power 108 having voltage (e.g., 5 VDC) that is lower than the voltage of solar power 47 but higher than the voltage of backup power 49 (e.g., 3.7V-4.2V DC). In addition, solar power 47 voltage and backup power 49 voltage may vary or oscillate over time so that the electric power supplied to power circuit 101 may not be steady (e.g., 24-40 V DC solar power, 3.7V to 4.2V backup power). Solar power 47 supplied from solar power assembly 40 or backup power 49 from battery 104 may vary depending on various conditions and factors, such as environmental (e.g., sun, temperature), hardware (e.g., type, condition, age, of PV panels, solar energy converter, battery, wiring, shielding, and others), rate of energy consumption/power (e.g., energy to pump and filter water, radio transmissions, etc.). Buck-and-boost converter 105 can be configured to receive power, either solar power 47 or backup power 49, condition the received power and provide it to water hub 100 ensuring that control circuit 110 receives stable and consistent control power 108 (e.g., voltage and current). Power connector 102 is configured to connect to renewable power supply 90, either solar power assembly 40 or rechargeable power supply 91a.

Charging module 103 (e.g., IP2312) can be configured to charge a rechargeable backup battery 104. When solar power is available, charging module 103 redirects part of the power delivered to power connector 102 to charge backup battery 104 (e.g., at maximum current of 3 A) and to cut-off charging when backup battery 104 reaches a full charge. Battery 104 may provide power to the water hub 100 as a secondary source when the solar power is not available (e.g., solar power assembly is not-functional, no sunlight).

Buck-and-Boost Converter 105 may comprise boost converter 105a and buck converter 105b. Boost converter 105a may be a DC-to-DC converter configured to step up (boost) backup power 49 (e.g., 4.2 VDC) to produce steady control power 108 (at, e.g., 5 VDC) that has higher voltage (or potential) than backup power 49 (at, e.g., 4.2). Boost converter 105a supplied with an input voltage may use pulse width modulation (PWM) to output voltage higher than the input voltage. Boost converter 105a may comprise a transistor (e.g., MOSFET) configured to switch on and off (or pulse) at a particular frequency, causing electric charge to be stored (e.g., accumulated on an inductor) during the switching cycle and then using the accumulated charge produce the output voltage. Boost converter 105a is configured to boost and stabilize backup power 49 voltage to produce control power 108 supplied to water hub 100 to at steady value (e.g., 5 VDC) suitable for the various components of water hub 100.

A buck converter 105b (e.g., XL4016) may be configured to step down the solar power 47 voltage (which may be as high as 40V) to a stable control voltage, of preferably 5V DC for control circuit 110. Power circuit 101 may also comprise an ON/OFF switch and a P-channel MOSFET (IRF9540NS). The P-Channel MOSFET is configured to disconnect the backup battery as a power supply when solar power is available, to ensure that all power through the buck converter is drawn from the solar panel. The ON/OFF switch controls the power supply from the output of the P-channel MOSFET, turning the smart water hub 100 on or off regardless of whether the power is coming from the solar panel or the battery.

Control Circuit 110 (shown with a dashed line) receives steady control power 108 from the buck-and-boost converter 105. Control power 108 voltage preferably is approximately 5VDC, but depending on implementation and type of the electronics and integrated circuits in water hub 100, control circuit 110 may operate at control power 108 voltage in the range of 3.7 VDC to 12 VDC, or even 2.6 VDC to 24 VDC. Control circuit 110 may comprise microcontroller 111, flow meters 112, water quality sensors 113 (e.g., TDS sensor), RTC (Real Time Clock) 114, global transmitter 116 (module for, e.g., GSM, satellite transmission), a logic level converter (LLC) 115, GPS module 117, and other sensors and components. GPS module 117 may provide geolocation for water treatment systems 1 facilitating access by maintenance personnel, enabling analysis of coverage for water purification in remote areas (e.g., especially when multiple systems are deployed), and various other benefits.

Microcontroller 111 receives system performance data 120 from flowmeter 112 and TDS sensors 113 and causes performance data 120 to be transmitted to a central portal 130 via global transmitter 116. Performance data 120 is stored in memory 111a (e.g., EEPROM). By way of example, microcontroller 111 may be an Arduino MEGA 2560 comprising 54 digital input/output pins, 16 analog inputs, a 16 MHz crystal oscillator, memory 111a, a USB connection, a power jack and a reset button.

Flowmeter 112 can measure volume and flow rate of water in system 1, for example, by detecting the movement of fluid (e.g., water) through a flowmeter tube and converting this data into an electrical signal. Flowmeter 112 may be a turbine, ultrasonic, hall effect, or electromagnetic sensors. Together with microcontroller 111, flowmeter 112 may measure, calculate, and record water volume data 126 including information about the volume of purified water 14 produced by system 1 in a specific amount of time (e.g., hour, day, month) as well as the total volume of purified water produced during the lifetime of system 1.

TDS sensor 113 comprises a probe 113a that can measure water quality based on concentration of dissolved solids in purified water 14 by passing a small electrical current between electrodes on probe 113a and measuring the electrical conductivity, which correlates to the TDS level in purified water 14. TDS sensor 113 may monitor purified water 14 and, if contamination or unsafe levels are detected, microcontroller 111 may be configured to produce a local alarm (e.g., audio, visual) and to transmit an alert to the central portal 130.

Logic Level Converter (“LLC”) 115 can safely interface between components of water hub 100 that operate at different voltage levels such between low-voltage components 106 (e.g., operating at 4.2 VDC) and high-voltage components 107 (e.g., operating at 5 VDC) preventing damage to components. An embodiment LLC 115 may interface the voltage signals 50 of low-voltage components 106 (shown in dashed line) comprising global transmitter 116 and GPS module 117 and the voltage signals 50 of high-voltage components 107 comprising microcontroller 111, RTC 114, flowmeter 112, and TDS sensor 113. LLC 115 may use transistors (e.g., MOSFETs) to translate voltage signals 50 up or down without affecting the response, speed, or integrity of the signals.

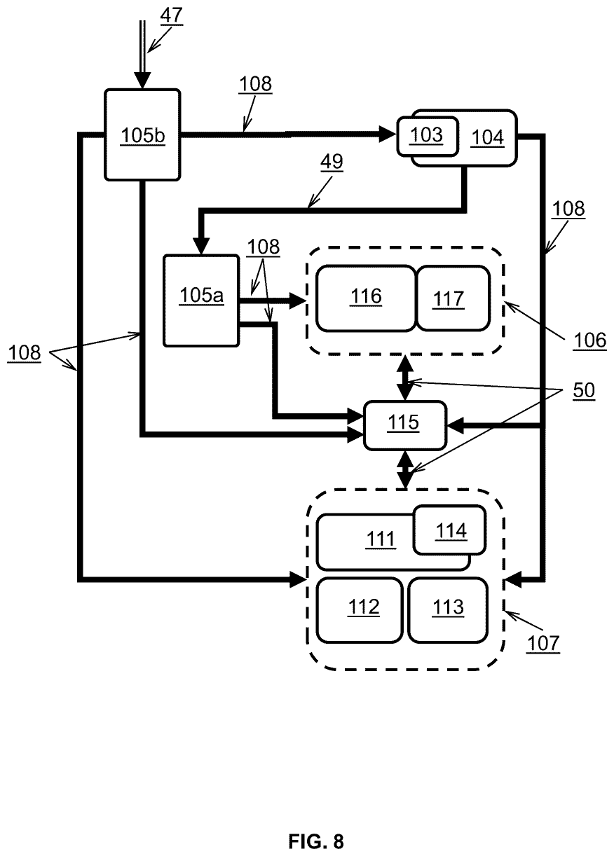

FIG. 8 provides an overview of the power flow in embodiments of water hub 100 configured to ensure a stable, efficient, and optimized power distribution throughout water hub 100. Solar power 47 (shown as a thick line, with arrow indicating electrical flow) with voltage of approximately 32 VDC may be supplied to buck converter 105b, which conditions the supplied solar power voltage and steps it down to the approximately 5 VDC voltage of control power 108 (shown as a thick line, with arrow indicating electrical flow). Control power 108 may power charging module 103 to efficiently charge battery 104. Control power 108 may also be supplied to high-voltage components 107 and through LLC 115 to low-voltage components 106 (shown in dashed line). Alternatively (e.g., during solar outage), battery 104 may supply backup power 49 (shown as a thick line, with arrow indicating electrical flow) ranging from 3.7 VDC to 5 VDC. Backup power 49 below the voltage rated for high-voltage components 107 (e.g., below approximately 4.4 VDC) may be supplied to high-voltage components 107 (shown in dashed line) through boost converter 105a.

Backup power 49 above the voltage rated for low-voltage components 106 (e.g., above approx. 4.4 VDC) may be supplied to low-voltage components 106 through buck converter 105b. Backup power 49 may also be supplied low-voltage components 106 and high-voltage components 107 through LLC 115 that is configured to step up or step down the voltage as needed.

Real Time Clock (“RTC”) 114 may keep track of time (e.g., current date, time) even when the system 1 and smart water hub 100 are powered off. RTC 114 may be implemented with a crystal oscillator and a battery backup or other RTC technologies to maintain accurate timekeeping. RTC 114 may keep track of data monitoring intervals, transmission intervals, and may provide to microcontroller 111 time information, enabling timestamping of system performance data 120 transmitted to central portal 130. RTC 114 may also be used to optimize energy consumption of smart water hub 100 by powering on and powering off different components of water hub 100 between active and sleep modes to conserve power and extend battery life. For example, RTC 114 may periodically power on microcontroller 111, flowmeter 111, and water quality sensor 113 to obtain and store into memory 111a water volume data 126 and water quality data 125. In another example, RTC 114 may power on microcontroller 111 and GSM module 116 at a pre-specified time to transmit data packet 129 comprising performance data 120 and power them off after successful transmission.

When deploying multiple water treatment systems 1 comprising smart water hubs 100, RTC 114 in each smart water hub 100 may be configured to wake up Global transmitter 116 and transmit performance data 120 at different (e.g., staggered) time periods to reduce the risk of data overlap or lost data, especially when systems are deployed in areas with poor connectivity.

Global transmitter 116 enables water hub 100 to connect to global communication networks without relying on wi-fi, or other local networks in remote locations. Transmitter 116 preferably utilizes GSM communication (Global System for Mobile Communications) module 116 due to the comparatively lower cost and wide availability of GSM technology. Other global communication technologies can also be implemented in embodiments of the present invention, including CDMA, LTE, satellite communication, and others. Global transmitter 116 is configured to communicate with microcontroller 111 to retrieve performance data 120 from memory 111a and transmit it in a data packet 129 to portal 130. Transmitter 116 may comprise an antenna port 116a configured to connect to an external antenna 116b for enhanced connectivity.

Water hub 100 is configured for structured data collection and transmission to ensure accurate real-time water monitoring while optimizing power consumption and maintaining energy efficiency. Embodiments of water hub 100 can aggregate performance data 120 on memory 111a continuously or in very short intervals (HOW LONG?—processor cycle?—250 ms?). For example, flowmeter 112 may be configured to continuously detect when water flow is present, measure water volume, and record cumulative water volume data 126 by adding new water volume readings to previously recorded data on memory 111a. In another example, water quality sensor 113 (e.g., TDS sensor) may be configured to continuously measure the water quality of purified water 14 and record water quality data 125 (e.g., TDS level measurement) in memory 111a.

Transmission of data packet 129 occurs periodically at a transmission interval 123 (e.g., every 2 hours) while water hub 100 is in active mode (e.g., six transmissions per 12 hours “awake” period). Preferably, transmission occurs during daytime alignment solar power availability to maximize solar power use and minimize power consumption from backup sources such as battery 104.

Performance data 120 may be transmitted within data packet 129. Performance data 120 may comprise information collected since the previous transmission (e.g., between two transmissions or the duration of transmission interval 123) or may comprise cumulative information collected over a certain time period.

Embodiments of water hub 100 may be configured to suspend data collection and storage (e.g., by de-energizing sensors) during transmission to enhance energy efficiency and reduce power consumption.

Data transmission packet 129 may comprise a unique identifier 121 for the smart water hub, RTC data (e.g., actual time, time since last transmission, etc.), system performance data 12 (e.g., water quality data 125, such as TDS, water volume data 126, such as volume of filtered water over a period, lifetime, since last transmission), GPS data 127 (e.g., global position, coordinates, address), one or more timestamps 118, and others. System performance data 120 may be associated with one or more timestamps 118 such as time of data collection and time of transmission.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention is not limited to the embodiments disclosed as the best mode contemplated for carrying out this invention, but that the invention will include all embodiments falling within the scope of the appended claims. Moreover, unless specifically stated, any use of the terms first, second, etc., do not denote any order or importance, but rather the terms first, second, etc. are used to distinguish one element from another.

I claim:

1. A fully self-contained water purifying system designed for rapid deployment, the system comprising:
a main casing mounted on wheels, wherein the main casing comprises a top surface and a main casing lid;
a pump connected to a prefilter via a delivery waterline, wherein the pump is configured to draw raw water from a water source and deliver the raw water to the prefilter;
a solar power assembly electrically connected to the pump and a water hub; and,
water taps mounted externally on the main casing;
wherein the main casing houses:
a supporting board;
the water hub;
the prefilter configured to prefilter the raw water;
an analog flowmeter;
a filtration briefcase configured to purify prefiltered water;
a water tank for purified water;
a taps header configured to distribute the purified water to the water taps;
a prefiltered waterline connecting the prefilter to the filtration briefcase, wherein the prefiltered waterline is configured to deliver the prefiltered water from the prefilter to the filtration briefcase;
a purified waterline connecting the filtration briefcase to the water tank, wherein the purified waterline is configured to deliver the purified water from the prefilter to the water tank; and,
a distribution waterline connecting the water tank to the taps header;
wherein the analog flowmeter is configured to measure a water volume of the purified water and display the water volume on a readout externally mounted on the main casing;
wherein the water hub is configured to:
collect in real-time performance data; and
transmit the performance data globally to a remote portal, wherein the performance data comprises water volume and water quality;
wherein the solar power assembly comprises two or more photovoltaic (PV) panels mounted on a hinged frame;
wherein the hinged frame is configured to enable a user to:
fold the solar power assembly into a folded state, wherein in the folded state the two or more PV panels fully overlap with each other; and,
unfold the solar panel assembly from the folded state to an extended state, wherein in the extended state the two or more PV panels form a single plane;
wherein for ease or transportation the main casing is configured to removably store the pump connected to the delivery waterline, the delivery waterline, and the solar power assembly in the folded state;
wherein for rapid deployment of the water purification system, the main casing is configured to enable the user to:
open the main casing lid to access the solar power assembly and the supporting board;
remove the solar power from the main casing;
unfold the solar power assembly into the extended state;
deploy the solar power assembly to convert solar energy to electricity by positioning the supporting board to support the solar power assembly in the extended state on the top surface of the main casing; and,
remove the pump from the main casing and position the pump in the raw water source; and,
wherein when deployed in sunlight, the solar power assembly is configured to:
power the pump;
cause the pump to extract raw water from the water source; and,
cause the pump to pump the extracted raw water to be filtered sequentially through the prefilter and the filtration briefcase to produce the purified water and to be stored in the water tank.

2. The system of claim 1, wherein the main casing further comprises:
a solar panel compartment;
a briefcase compartment; and,
a pump compartment comprising a pump cover;
wherein the filtration briefcase comprises interchangeable filtration units configured to purify the prefiltered water and deliver the purified prefiltered water through the purified waterline;
wherein the pump compartment is configured to store the pump and the delivery waterline when the pump is not in use;
wherein the solar panel compartment is configured to fully accommodate the solar power assembly in the folded state while the solar panel is electrically connected to the pump and the water hub;
wherein the briefcase compartment is configured to removably house the filtration briefcase within the main casing;
wherein, when the casing lid is open, the main casing and the solar panel compartment are configured to:
enable the user to slide the solar power assembly out from the solar panel compartment; and,
enable the user to slide the solar power assembly in the folded state into the solar panel compartment;
wherein, when the casing lid is closed, the main casing is configured to:
prevent access to the solar power assembly stored in the solar panel compartment; and,
prevent access to the filtration briefcase housed in the briefcase compartment;
wherein, when the solar power assembly is deployed, the main casing and the briefcase compartment are configured to:
enable the user to remove the filtration briefcase from the briefcase compartment;
enable the user to insert the filtration briefcase into the briefcase compartment; and,
enable the user to access the interchangeable filtration units inside the filtration briefcase.

3. The system of claim 2, wherein the main casing further comprises a panel edge support;
wherein the supporting board is configured to support the solar power assembly in the extended state at varying angles to incident sunlight when the solar assembly is deployed on top of the main casing; and,
wherein, when the solar power assembly is deployed on top of the main casing, the panel edge support is further configured to:
prevent the solar power assembly from sliding forward; and,
prevent the solar power assembly from sliding sideways.

4. The system in claim 3 wherein the solar power assembly further comprises:
straps attached to the hinged frame configured to enable the user to utilize the straps to slide the solar power assembly in the folded state in or out of the solar panel compartment; and,
a stabilizer clip configured to:
cover a hinged connection of the hinged frame; and,
prevent the solar power assembly from folding when in the extended state.

5. The system of claim 2, wherein the filtration briefcase further comprises:
a briefcase inlet comprising an inlet easy-connector removably connected to the prefilter waterline;
a briefcase outlet comprising an outlet easy-connector removably connected to the purified waterline;
a cartridge inlet connector connected to the briefcase inlet; and,
a cartridge outlet connector connected to the briefcase outlet;
wherein the inlet easy-connector is configured to enable the user without using any tools to quickly and easily connect or disconnect the briefcase inlet and the prefiltered waterline;
wherein the outlet easy-connector is configured to enable the user without using any tools to quickly and easily disconnect or connect or disconnect the briefcase outlet and the purified waterline;
wherein, when the solar power assembly is deployed, the main casing, the briefcase compartment, and the filtration briefcase are configured to enable the user to:
remove the filtration briefcase from the briefcase compartment by utilizing the inlet easy-connector and the outlet easy-connector to disconnect the filtration briefcase from the prefilter waterline and the purified waterline;
and, insert the filtration briefcase in the briefcase compartment by utilizing the inlet easy-connector and the outlet easy-connector to connect the filtration briefcase to the prefilter waterline and the purified waterline;
wherein the interchangeable filtration cartridges comprise a first filter cartridge and a second filter cartridge;
wherein the cartridge inlet connector, the cartridge outlet connector, the first filter cartridge, and the second filter cartridge are configured to enable the user to:
connect the first filter cartridge and the second filter cartridge in a serial filtration configuration for multistage filtration between the briefcase inlet and the briefcase outlet; and,
connect the first filter cartridge and the second filter cartridge in a parallel filtration configuration for increased filtration throughput between the briefcase inlet and briefcase outlet;
wherein the first filter cartridge is selected from the group consisting of reverse osmosis cartridge, ultrafiltration units, nano-filters, and activated carbon; and,
wherein the second filter cartridge is selected from the group consisting of reverse osmosis cartridge, ultrafiltration units, nano-filters, and activated carbon.

6. The system of claim 5 further comprising:
a prefilter waste line;
a briefcase waste line;
a waste line; and, a backwash valve connected to the prefilter waste line, the briefcase waste line, and the waste line;
wherein the filtration briefcase further comprises a briefcase waste outlet equipped with a waste outlet easy-connector removably connected to the briefcase waste line;
wherein the interchangeable filtration cartridges are further configured to expel the filtration waste through the briefcase waste outlet;
wherein the prefilter further comprises a prefilter waste outlet connected to the prefilter waste line;
wherein the prefilter is configured to expel the filtration waste through the prefilter waste outlet; and, wherein the backwash valve is configured to:
receive the filtration waste from the prefilter waste line;
receive the filtration waste from the briefcase waste line; and,
enable a user to open the backwash valve to cause the filtration waste to be expelled through the waste line.

7. The system in claim 5 wherein the pump is a submersible pump configured to be submersed into the water source;
wherein the submersible pump is enclosed in an external casing configured to protect the submersible pump by mechanically filtering the raw water from the water source;
wherein the storage water tank comprises a level sensor configured to send a control signal to the submersible pump indicative of a water level in the water tank;
wherein the submersible pump is configured to stop or start pumping raw water according to the control signal;
wherein the water tank has a water storage capacity of at least 250 liters;
wherein the solar power assembly has a surface area of at least 35 square feet in the extended state;
wherein the filtration briefcase has a depth of at least 7 inches, a length of at least 48 inches and a width of at least 20 inches;
wherein the prefilter has a volume of at least 1 cubic feet;
wherein the main casing has a volume of no more than 75 cubic feet and a height of no more than 4 feet; and, wherein the water taps are mounted at a level below a bottom water level of the water tank.
